(19) United States
(12) Patent Application Publication
(10) Pub. No.: US 2003/0047710 A1
(43) Pub. Date: Mar. 13, 2003

(54) Chemical-mechanical polishing

(75) Inventors: Suryadevara V. Babu, Potsdam, NY (US); Anurag Jindal, Potsdam, NY (US); Sharath Hegde, Potsdam, NY (US)

Correspondence Address: Alvin Isaacs, Esq., 9544 Hawksmoor Lane, Sarasota, FL, 34238-3221, US

(73) Assignee: NYACOL NANO TECHNOLOGIES, INC

(21) Appl. No.: 09/950,612

(22) Filed: Sep. 13, 2001

(51) Int. Cl. C09K 13/00

(52) U.S. Cl. 252/79.1

(57) ABSTRACT

An abrasive slurry for chemical-mechanical polishing, e.g. to planarize metal and silicon wafers employed in the fabrication of microelectric devices and the like, the slurry consisting essentially only of a mixture of at least two inorganic metal oxides to provide superior performance in properties such as improved oxide and metal polish rates, controlled polish rate selectivity, low surface defectivity and enhanced slurry stability over that obtainable with a single inorganic metal oxide abrasive material.

### BACKGROUND OF THE INVENTION

Chemical-mechanical polishing, commonly referred to as “CMP”, has emerged as the only technique to planarize metal and dielectric films for the fabrication of microelectric devices on the integrated circuits (“IC's”).

The process of manufacturing integrated circuits typically consists of more than a hundred steps during which a large number of IC's are formed on a single silicon wafer. The challenges involved in the chip manufacture make the integrated circuit industry one of the most demanding industries in recent time.

Aluminum and silicon dioxide (SiO₂) have been conventionally employed for fabricating the interconnects during chip during chip manufacturing. Aluminum is used as a conductor to connect different devices and silicon dioxide is used as an insulating material between the conductors and between the devices.

However, in the last few years, several economic and technical reasons have led to the use of copper and a group of insulating materials known as “low-k” materials in lieu of aluminum and silicon dioxide, respectively. This combination has several advantages. Copper has lower electrical resistance than does aluminum and is more resistant to electromigration; while low-k dielectrics have lower dielectric constants than conventional silicon dioxide and facilitate faster devices. Accordingly, integration of Cu/low-k dielectrics enhances overall device performance !

Yet, the integration of copper into the chip requires special processing techniques. Conventional methods such as Reactive Ion Etching (“RIE”), which have been used for aluminum based integrated circuits cannot be employed to pattern copper as needed for interconnects in the high performance chip, since there are no known chemical compounds of copper which are volatile at or around room temperature. Presently, copper is incorporated into the chip utilizing the damascene process (which will be described hereinafter) and the excess copper is then removed by chemical-mechanical processing to achieve global planarization.

Polishing of other materials like tantalum, silicon dioxide (commonly called as oxide) and silicon nitride (commonly called as nitride) has also gained importance in recent years for a variety of reasons.

Tantalum or tantalum nitride is used as a liner layer for copper, which serves two purposes. First it acts as a diffusion barrier layer between the copper and the underlying silicon dioxide/silicon dioxide to prevent diffusion of copper into the silicon/silicon dioxide matrix. Secondly, it acts as an adhesive enhancer between copper and silicon dioxide.

Damascene process requires that the polish rate selectivity (the ratio of polish rate of the top layer to that of the underlying layer) between copper, the primary conductor material and the underlying tantalum barrier layer be on the order of around one. However, it is difficult to obtain such polish rate selectivity between copper and tantalum because copper is relatively softer and more reactive than tantalum.

Silicon oxide and silicon nitride polishing are crucial because of the Shallow Trench Isolation (“STI”) for the isolation of two active devices. For integrated circuit devices to function properly, each of the many million transistors should be properly isolated so that the functioning of one transistor does not interfere with that of an adjacent transistor.

In the current generation devices, an improved isolation, greater packing density and superior dimensional control is achieved by using the aforementioned Shallow Trench Isolation method. STI is formed by etching a trench through the silicon nitride and the silicon oxide layer into the silicon to a predetermined depth. Silicon oxide is then deposited over the entire wafer and into the trench opening in the silicon nitride using a special technique called Chemical Vapor Deposition (“CAD”. Chemical-mechanical polishing is then applied to remove excess CAD silicon oxide stop on the protective silicon nitride. The nitride is then etched out using strong acids.

CMP must stop when the nitride layer is reached and this requires a very high oxide to nitride selectivity slurry for CMP. Accordingly, it is stressed that CMP plays a very big role in the success of the vitally important STI process.

In the CMP process, as the name of the process infers, planarization is achieved through the contributions of both chemical reactions and mechanical abrasion. The chemical reactions take place between the slurry and the material being polished. Mechanical abrasion of the film is caused by the interaction between the pad, the abrasives and the film. Accordingly, the three major components of a CMP process are the film, the pad and the slurry. Since the process is very well known in the art, including the aforementioned key components, it need not be discussed in much detail herein. Accordingly, a brief description in this discussion of the BACKGROUND OF THE INVENTION will suffice.

The pad, typically made from polyurethane foam, is a media enabling the transfer of mechanical forces to the surface being polished and the slurry provides both chemical and mechanical effects. Various parameters such as polish rates, defectivity, planarity, and polish rate selectivity with respect to the underlying material, uniformity across the wafer and a single die, post-CMP ease of cleaning and slurry dispersion ability are the factors considered to optimize the slurry performance.

A typical slurry consists of a solid phase of abrasive material and a liquid chemical solution phase.

The abrasives in the slurry play the very important role of transferring mechanical energy to the surface being polished. Illustrative abrasives for this purpose include silica (silicon dioxide, SiO₂) and alumina (aluminum oxide, Al₂O₃). Ceria (cerium dioxide, CeO₂) is the most popular abrasive for the polishing of the glass and (recently) oxide films for STI.

The abrasive-liquid interactions, through chemical and physical actions, play a very important role in determining the optimum abrasive type, size, shape and concentration. The abrasives, however, can also have a chemical effect as in the case of glass polishing with ceria abrasives where the ceria forms a poorly understood chemical bond with the glass surface.

CMP is per se old prior to the present invention and has, for example, been used in glass polishing and silicon wafer polishing prior to integrated circuit fabrication for quite some time. Silicon dioxide employed in integrated circuit manufacturing is a form of silicate glass, so the two materials have similar mechanical and chemical properties. Silicon dioxide polishing is typically performed near pH 10 because of enhanced dissolution and chemical interaction in that pH regime. The dissolution rate is enhanced by the compressive stress that occurs during particle abrasion. Ceria and zirconia have been found to possess a special “chemical tooth” property that increases the silicon oxide removal by many orders of magnitude.

Conventionally, silica particles alone have been used as the abrasives for silicon oxide and nitride polishing. Ceria based slurries, which have high removal rates of oxide and high polish rate selectivity of oxide to nitride often cause slurry-induced scratches on the oxide surface. These scratches are detrimental to proper functioning of the integrated circuit devices. Deep scratches should be eliminated because they may attack the silicon substrate and negate oxide integrity.

Stated simply, the stated task of the present invention is to provide novel slurry formulations for CMP processing which provide superior results over what is obtainable with the slurries heretofore employed in CMP processing.

### BRIEF DESCRIPTION OF THE INVENTION

In accordance with the present invention this task has been solved in a simple and elegant cost-effective manner by providing novel slurry formulations comprising two types of abrasive particles, in contrast to the earlier prior art ones in which a single abrasive is employed to control the polish rate, surface defectivity and slurry stability.

Applicants have unexpectedly discovered that improved oxide and metal polish rates, controlled polish rate selectivity, low surface defectivity and enhanced slurry stability all can be achieved by utilizing an abrasive slurry consisting essentially of two or more of the per se known inorganic oxides, a mixture of either alumina and silica or alumina and ceria being preferred.

These mixed abrasive slurries of the present invention constitute an unexpected technological advancement in CMP processes. Specifically, it has been unexpectedly observed that the mixed abrasive slurry provides superior performance to slurries of either abrasive alone, as will be apparent from the performance data that will appear hereinafter.

### DETAILED DESCRIPTION OF THE INVENTION

As was heretofore mentioned, the present invention is directed to chemical-mechanical polishing and more particularly with such processes utilizing mixed slurries. Specifically, in accordance with this invention it has been discovered that improved oxide and metal polish rates, controlled polish rate selectivity, low surface defectivity and enhanced slurry stability all can be achieved by employing in the CMP process a slurry consisting essentially of a mixture of abrasives as will be described in detail hereinafter, which abrasive slurries perform much better than slurries containing one abrasive species alone.

At this point in the description of the invention, it is thought appropriate to make mention of the prior art known to Applicants, namely the patents brought to their attention in a novelty search made prior to initiating a patent application directed to their invention.

While these patents are recited in an INFORMATION DISCLOSURE STATEMENT (Form PTO-1449) filed concurrently with the instant application, attention is invited to the following patents contained therein which will serve to illustrate the state of the prior art as viewed through Applicants' eyes and their inventive contribution thereover.

The patent literature is replete with references to CMP processes reciting the use of a slurry including an inorganic metal oxide abrasive material selected from the group consisting of alumina, titania, zirconia, germania, silica, ceria, and mixtures thereof As examples of such patents, mention may be made of U.S. Pat. Nos. 5,759,917 issued to Grover et al.; 5,958,288 issued to Mueller at al.; 5,980,775 issued to Grumbine et al.; 6,068,787 issued to Grumbine et al; and U.S. Patent Application Publications No. US 2001/0006225 A1 issued to Tsuchiya et al. and US 2001/0008828 A1 issued to Uchikura et al., all of which are cited in the aforementioned INFORMATION DISCLOSURE STATEMENT.

However, to the best of Applicants' recollection, in no instance was there a specific example reciting a slurry containing a combination of two or more of the above inorganic metal oxide abrasives or any specific example directed to any such combination. Instead, in all such instances reciting the above-mentioned known class of inorganic metal oxide abrasives, patentable novelty was predicated upon other reagents in the slurry, e.g. at least one of the following specific reagents: a carboxylic acid, a salt, a soluble metal, a catalyst, an oxidizing agent, a stabilizer, a pH buffering agent, a chelating agent, an adhesion-inhibitor, a polishing rate adjuster, etc.

As distinguished therefrom, the present invention is directed to a slurry consisting essentially of only the inorganic metal oxides to be discussed in detail hereinafter.

By way of illustration, mention is made specifically of the following references cited in the aforementioned INFORMATION DISCLOSURE STATEMENT.

In U.S. Pat. No. 5,759,917 issued to Grover asserts improved polish rate selectivity between oxide and nitride polish rates for what is referred to as Shallow Trench Isolation application using a slurry containing carboxylic acid, a salt and a soluble cerium compound. The pH of the slurry ranges from 3 to 11, preferably from 3.8 to 5.5. The slurry also contains an abrasive which may be selected from the group including alumina, titania, zirconia, gernania, silica, ceria and mixtures thereof Preferred abrasives suitable for the CMP slurries of the patented invention are said to be silica and ceria. [In examples 3,4 and 5, the ceria is stated to have been purchased from Nyacol Products, the assignee of the instant invention.] In yet another example (Example 7), it has been shown that fumed silica when used with acetic acid and ammonium cerium nitrate yields better polish rate selectivity between the oxide and nitride. In this case, cerium is present as a soluble ion and not as an abrasive.

The patented invention differs from the invention of the instant application in that the latter emphasizes the use of two different types of inorganic abrasives without the need of any other effective ingredients, specifically a carboxylic acid or a soluble cerium salt as recited in the patent. As will be discussed hereinafter, it has been demonstrated that the instant invention for metal polishing with an admixture of two types of particles, with or without an additional chemical compound, yields better polishing results. Only de-ionized (DI) water for the slurry is needed in some cases, while hydrogen peroxide is needed in other cases.

In the aforementioned '8828 patent application publication of Uchikura et al., an aqueous dispersion for CMP of copper, barrier (Tantalum or Tantalum nitride) and insulating films of oxide were provided. The aqueous dispersion includes at least an abrasive, water and a polishing rate adjusting component.

It was clearly stated that the abrasive consists of at least one type of particles selected from among (a) inorganic particles; (b) organic particles; and (c) inorganic/organic composite particles [¶ 0025]. Various candidates for the inorganic and organic particles were suggested. The essence of their invention is understood to be the recited maleic acid ion for adjusting the polishing rate. Several examples in this publication also discuss the use of hydrogen peroxide as an oxidizing agent apart from the polishing rate-adjusting agent.

Nevertheless, no example is found in the patent where more than one type of inorganic particle is used in the slurry.

This publication differs from Applicants' work in the way that the polish rate is adjusted. As will be described, no additional reagent is employed in the present invention for polish rate adjustment.[Having said this, hydrogen peroxide, however, has been used as an oxidizing agent in some of this work related to metal polishing.]

In the aforementioned '6225 patent application publication, a slurry designed for polishing copper films is described in paragraphs 0027-0029 as containing an abrasive, an oxidizing agent and an adhesion-inhibitor (citric acid). It is stated (¶ 0029) that the abrasive can be alumina, silica, titania, zirconia, germania, ceria and mixtures of two or more kinds of these metal oxides. Of these, silica grains and alumina grains are preferred. The formulations for ten examples are recited in Table 1 of their application. In these examples, the abrasive is either alumina or silica, but not both.

However, the invention is said (¶ 0025) as being the use of citric acid to prevent adhesion of a polishing product to a polishing pad. It therefore follows that all of the claims in the application recite the presence of an adhesion-inhibitor generically (as in claim 1) or citric acid, specifically (as in claim 2).

To summarize, absent the specific recitation of any reason for employing two or more of the above-recited inorganic metal oxide abrasives and examples to this effect, one might well assume that the recitation following the Markush grouping in these patents to the effect that mixtures of two or more kinds of these metal oxides are also contemplated can only be presented by the skilled patent attorney drafting the patent application who sees no reason why one could not do so, but offers no reason why one skilled in the art should in fact do so.

Having reviewed the reasons why the cited art known to Applicants do not disclose or suggest the use of an abrasive slurry consisting essentially of two or more inorganic oxide abrasives, i.e. to the exclusion of reagents performing specific functions critical to the patented inventions of others, attention is now invited to what Applicants specifically assert to be their inventive contribution to the CMP processing art.

Of the six inorganic oxides recited in the patent literature, Applicants admittedly have only at present studied the combination of alumina and ceria and alumina and silica for use in CMP slurries. Accordingly, the following detailed description will necessarily be limited to the test results and other data which have actually been performed.

Oxide Polishing

Specifically, to illustrate the practice of this invention, various materials including thermal oxide (a special kind of silicon dioxide grown by thermal treatment of silicon wafer), copper disks and tantalum disks have been polished using a variety of abrasives and mixed abrasive slurries. The abrasives selected for polishing these materials were alumina (supplied by Ferro Corp.); fumed silica (supplied by Degussa Corp.); and ceria (supplied by Ferro Corp. and Nyacol Nano Technology, Inc.)

Thermal oxide was polished with ceria (Product code DP6255) supplied by Nyacol Nano Technologies, Inc. (NNTI), alumina (3.5 g/cc bulk density, supplied by Ferro Corp.); and ceria also supplied by Ferro Corp. Six inch oxide wafers were polished using a Westech-372 polisher with the following parameters employed:

Pressure: 6 psi

Relative linear velocity: 50 cm/s

Pad: IC-1400

Slurry flow rate: 200 ml/min

Polishing time: two minutes

The ratio of ceria to alumina employed in the practice of this invention is preferably on the order of ˜1:1 to ˜5:1, with the polish rate increasing with increase of ceria in the slurry mixture. The ceria will preferably possess a mean primary particle size less than 20 nm and most preferably 5 nm or smaller; while the alumina is preferably of a magnitude larger, e.g. at least 50 nm and most preferably at least 100 nm. The pH for oxide polishing is preferably carried out at a pH of ˜10.

Table I shows the polish rates of the thermal oxides with the different slurry compositions.

TABLE I
Thermal oxide polish rates with single abrasive or with mixed abrasive
slurries

| | Thermal | Surface |
|---|---|---|
| | Oxide Polish | Roughness |
| Abrasive | Rates (nm/min) | (nm) |
| 1.5% Ceria (DP6255) at pH 10.0 | 7 | — |
| 6.0% Ceria (DP6255) at pH 10.0 | 12 | — |
| 1.5% Ceria (Ferro) at pH 10.0 | 504 ± 25 | 1.4 |
| 1.5% Alumina (3.5 g/cc) at pH 10 | 92 ± 4 | 13.0 |
| 1.5% Alumina (3.5 g/cc) + 1.5% | 163 ± 8 | 44.5 |
| Ceria (Ferro) at pH 10 | | |
| 1.5% Alumina (3.5 g/cc) + 1.5% | 194 ± 6 | 0.8 |
| Ceria (DP6255) at pH 10 | | |
| 1.5% Alumina (3.5 g/cc) + 3.0% | 272 ± 5 | 0.8 |
| Ceria (DP6255) at pH 10 | | |
| 1.5% Alumina (3.5 g/cc) + 6.0% | 331 ± 16 | 0.9 |
| Ceria (DP6255) at pH 10 | | |

As shown, ceria DP6255 (from Nyacol) alone does not polish the oxide, even at 6 wt. % particle concentration. However, when this ceria is mixed with alumina, the polish rates increase to approximately 330 nm/min. Alumina alone gives a polish rate of approx. 90 nm/min with a very poor surface quality. A monotonic increase in the polish rate of oxide films is observed with an increase in the concentration of ceria in the mixture of Ferro alumina and Nyacol ceria particles.

Ceria supplied from Ferro Corp., on the other hand, gives a polish rate of 500 nm/min with 1. 5 wt % particle concentration, but with relatively poor surface quality.

As is seen from Table I, the surface quality improves with the mixed abrasive slurries containing Ferro alumina and Nyacol ceria The root mean square roughness values (S_{q}) after polishing with the mixed abrasive slurry with the Nyacol ceria is less than 0.9 nm as compared to 1.4 nm obtained after polishing with 1.5% Ferro ceria alone.

The frequency of surface defects such as pits is extremely low with the mixed abrasive slurry. Furthermore, the slurries containing alumina alone or alumina and ceria (both from Ferro) generate a very poor surface finish with surface roughness' of 13 nm and 44.5 nm, respectively.

As mentioned above, from Applicants' research, the preferred mixed slurry for oxide polishing is alumina and the ceria (DP6225) from Nyacol Nano Technologies, Inc., assignee of the present invention, which ceria outperformed the ceria from Ferro Corporation, although the Ferro ceria alone did provide superior polish rates over either abrasive of the mixture alone.

In another study, it was observed that the stability of a slurry containing Ferro alumina and Nyacol ceria at pH 10 was the best among all the slurries discussed above. Since the shelf life of the slurry is very long, this is observation constitutes a very significant improvement from the practitioner's point of view.

Therefore, from the studies carried out, it was unequivocally concluded that the mixed abrasive slurry is an exceedingly attractive candidate for the use in oxide polishing.

Metal Polishing

A slurry designed for CMP polishing of metal should optimally provide (a) reasonable polish rates; (b) acceptable polish selectivity with respect to the underlying layer; (c) low surface defects after polishing; and (d) good slurry stability, i.e., high shelf life. Since developing a slurry containing a single abrasive meeting all of the above criteria remains a very difficult challenge, Applicants have also directed their attention to mixed abrasives as a viable solution to solve this challenge.

Theorizing that smaller abrasive particles would form a sheath around the bigger particles in the slurry and thereby enhance the particle-film interactions, Applicants concluded that, as in the above-mentioned oxide embodiment, a relatively small abrasive particle should be employed along with a relatively large particle one, the smaller particles most preferably being of a magnitude smaller than the larger particles in the abrasive slurry. For the smaller abrasive particles, silica having a mean primary particle size of ˜10 to ˜50 is considered to be optimum; while the mean primary particle size of the larger particle size abrasive, alumina, should be at least 50 nm and most preferably at least 1100 nm. The ratio by weight of the respective particle sizes should be on the order of 1:10 to 10:1. For optimum copper and tantalum polish rate selectivity, the pH of the slurry should be 4 or 10.

In the experimental work performed by Applicants, disc polishing experiments were carried out using a bench-top Struers® DAP-V polisher and 3 mm thick copper and tantalum discs (99.999% pure) with a cross sectional area of 7.9 cm². The table speed was set at 90 rmp and the disc was held stationary. The average resultant linear velocity across the disc was ˜50 cm/s. The applied downward pressure was approx. 6.3 psi (41.4 1N/m². Alumina particles having a mean particle size of 220 nm with α and θ crystallographic orientations supplied by Ferro Corporation were used, bulk density=3.5 g/cm². Fumed silica particles from Degusso Corporation with specific surface area in the range of 35-65 m²/g and average particle size of 40 nm were also used. The solution pH was adjusted with diluted HCl/KOH, as appropriate. Suba-500 pads from Rodel Inc. were used for all polishing experiments.

Three sets of Cu and Ta discs CMP experiments were performed for the different slurry chemistries: (1) polishing using single abrasive slurries containing 0 to 3.0 wt. % alumina particles; (2) polishing only with silica particles in the concentration range of 0 to 3.0 wt. %; and (3) polishing with mixed abrasive slurries with total loading of 3.0 wt. %. Concentrations of alumina and silica in these mixed slurries ranged from 0 to 3.0 wt. % each. Three solution chemistries, namely DI water at pH 4, at pH 10 and 5% H₂O₂ at pH 10.

The copper polish rates increased monotonically from 0 to ˜280 nm/min with an increase in the concentration of alumina particles in the slurry. Silica, on the other hand, did not polish copper, even at 3 wt. % particle loading. Not surprisingly, when both particles were dispersed together with varied concentrations of alumina and silica particles at a total particle loading of 3 wt. %, it was found that copper polish rates decreased with an increase in the silica particle concentration. As alluded to above, it is believed that the silica particles, which are softer and have primary sizes that are smaller than those of the alumina particles, form a sheath around the alumina particles, thereby hindering the abrasion of the copper.

The mechanism of tantalum removal in de-ionized water, in contrast, is different from copper removal. Tantalum forms a compact, impervious and continuous passive oxide film of tantalum pentoxide, which is hard and thermodynamically stable at all pH values. However, silica removes the sub-layer through so-called “chemical tooth”.

Tantalum polish rates with alumina or silica, as single abrasives, increase with an increase in the concentrations of the abrasives. With the mixed slurries, however the tantalum polish rate behavior is quite different. There is a maximum in the tantalum polish rate at 0.5% alumina and 2.5% silica at pH 4. The increased tantalum removal rate at this concentration of the mixed abrasive slurry is due in part to interplay between the abrasive action of alumina and the “chemical tooth” property of silica surrounding the alumina particles. The polish rate selectivity between copper and tantalum has been found to be much closer to unity for this mixed abrasive slurry composition.

It has been reported earlier (S. Ramarajan et al., Electrochemical and Solid State Letters, 3(5), pp. 232-234 (2000)) that electrostatic interactions between the particles and the film surface play an important role in determining the polish rates of Tantalum in distilled water. Iso-electric point of the mixed abrasive slurries increases from 2.2 to 9.1 as their composition is changed from pure silica to pure alumina, with the total solid concentration being held at 3 wt. %. Mixed abrasive slurries with 0.5% alumina and 2.5% silica have an iso-electric point near 4, making these slurries less stable at pH 4.

Nevertheless, the polish rate selectivity between copper and tantalum is observed to be very favorable for this mixed slurry abrasion.

As was observed above, silica does not polish copper in distilled water even at the particle loading of 3 wt. %; while alumina polishes copper at a moderate rate of 18 to 30 nm/min in the concentration range of 0.5 to 3.0 wt. %. However, quite unexpectedly, the copper polish rate reaches a maximum of about 80 nm/min with the mixed abrasive slurry at a particle concentration of 1.5% alumina and 1.5% silica. Interestingly, at the other compositions of the mixed abrasive slurry, the copper polish rates are about the same as those of single abrasive slurries containing alumina. However, when 5% hydrogen peroxide is added to the system at pH 10, the copper polish rates increase for all the slurries, with a large increase observed for both alumina and the mixed abrasive slurry. This is presumed to be due to the formation of a softer sub-layer. (Y. Li, et al., Proc. Electrochem. Soc. 198th Meeting, Phoenix, Ariz., Oct. 22-27 (2000)). Also, with these mixed abrasives in 5% peroxide at pH 10, the copper polish rates differ only slightly from those of alumina slurries.

In experiments with and without 5% hydrogen peroxide in distilled water at pH 10 using single and mixed abrasives, tantalum polish rates with silica abrasives were found to be higher than those with alumina particles, and the polish rate increased with increasing concentration of silica abrasives. Tantalum polish rates with the mixed abrasives decreased with a decrease in the concentration of silica.

However, with the addition of 5% hydrogen peroxide at pH 10, tantalum polish rates increased rapidly with alumina concentration for both alumina and mixed abrasive slurries.

Stability of the slurries in distilled water with and without 5% hydrogen peroxide were also evaluated. It was observed that the slurry becomes less stable with an increase in alumina concentration. A slurry with only silica was the most stable.

Polishing of Cu and Ta Films on Si Wafers

Blanket copper and tantalum films on silicon wafers were polished using a limited set of slurries and the results are reported in Tables II and III, below. These Tables show the copper and tantalum film polish rates and surface roughness values for 6″ wafers after CMP with 5% H₂O₂ in distilled water at pH 10 with single abrasive slurries containing 2.5% alumina or 2.5% silica; and mixed abrasives slurries containing 2.5% alumina and 0.5% silica. For comparison, disc polish rates from earlier tests are also tabulated.

The polish rates of tantalum films are significantly different from those of tantalum discs, while there is only a smaller discrepancy between the polish rates of copper films and copper discs.

Tantalum disc polish rates are higher than those of tantalum films, partly due to the surface hardness of these two materials, as shown in Table IV, below. Since the micro-hardness values of the materials, as measured by a Triboscope® Nano-Mechanical Test instrument, are a function of the contact depth, all of the values reported here are at the fixed depth of 30 nm. It has been widely reported that the surface hardness of the films significantly affects the removal rates (S. Ramarjan et al., Proc. Material Research Society Symposium, 566, pp. 123-128 (2000); Tseng et al., Thin Solid Films, 290-291 (1996)), and therefore polish rates of films and discs are different. Apart from hardness, grain size and structure of the films also affect the polishing behavior.

As shown in Tables II and III, there has not been significant improvement in the surface roughness of polished films, even with the mixed abrasives. However, polishing with different compositions of mixed slurries is continuing and it is anticipated that the surface quality of both copper and tantalum films will be dramatically improved by optimizing the slurry composition.

For instance, as discussed earlier in the description of oxide polishing, Applicants have found very significant improvements in oxide surface roughness using mixed abrasive slurries containing ceria and alumina. There is no reason to assume that similar improvements in surface roughness in metal films could not be obtained with mixed abrasive slurries in CMP procedures. 1

TABLE II
Cu wafer and disc polish rates with single and mixed abrasive slurries

| | Polish Rate | | |
|---|---|---|---|
| | (nm/min) | | RMS Roughness |
| Slurry Composition at pH 10 | Film | Disc | (nm of wafers) |
| 2.5% Alumina + 5% H₂O₂ | 270 ± 40 | 238 | 0.6-0.7 |
| 2.5% Silica + 5% H₂O₂ | 27 ± 10 | 26 | 1.0-1.3 with |
| | | | heavy scratches |
| 2.5% Alumina and 0.5% Silica + | 257 ± 13 | 196 | 0.6-0.7 |
| 5% H₂O₂ | | | |

TABLE III
Ta wafer and disc polish rates with single and mixed abrasive slurries

| | Polish Rate | | |
|---|---|---|---|
| | nm/min | | RMS Roughness |
| Slurry Composition at pH 10 | Film | Disc | (nm of wafers) |
| 2.5% Alumina + 5% H₂O₂ | 48 ± 2 | 175 | 0.4-0.6 |
| 2.5% Silica + 5% H₂O₂ | 6 ± 4 | 27 | 0.7-1.2 with |
| | | | deep pits |
| 2.5% Alumina and 0.5% Silica + | 52 ± 3 | 191 | 0.4-0.6 |
| 5% H₂O₂ | | | |

TABLE IV
Micro-hardness values of Cu and Ta discs and films

Microhardness (Gpa)

| Material | Film | Disc |
|---|---|---|
| Copper | 2.6 | 2.0 |
| Tantalum | 14.5 | 3.5 |

To summarize the experimentals on metal polishing in the practice of this invention, CMP of metal discs and metal films on silicon wafers were performed with mixed abrasive slurries containing different compositions of alumina and silica particles, both with and without peroxide, in de-ionized water at pH 4 and pH 10.

Mixed abrasive slurries are very promising in optimizing slurry characteristics with controllable slurry stability, enhanced polish rates, good copper to tantalum polish rate selectivity and improved surface quality.

Maximum tantalum polish rate in DI water was observed with a mixed abrasive slurry composition of 2.5 wt. % silica and 0.5 wt. % alumina. Maximum polish rate for copper at pH 10 were observed in a mixed dispersion of 1.5 wt. % alumina and 1,5 wt. % silica in DI water.

Zeta potential measurements of these slurries indicated a monotonically increasing iso-electric point with changing slurry composition, suggesting a very strong dependence of slurry stability on pH.

Copper to tantalum polish rate selectivity close to unity was observed while polishing copper and tantalum discs over a wide spectrum of mixed abrasive slurry compositions with 5 wt. % peroxide in distilled water at pH 10.

Surface defect analysis of polished copper and tantalum films exhibit a potential to lower the extent of defects through tailored compositions of mixed abrasive slurries. These results need to be further validated for the polishing of copper and tantalum films on silicon wafers.

By way of recapitulation, Applicants have discovered that a mixed abrasive slurry consisting essentially of a proper composition of two different types of abrasives can yield better chemical-mechanical polishing performance than a slurry containing one of the abrasives alone.

Since certain changes may be made without departing from the scope of this invention, it is intended that the foregoing description should be considered by way of illustration and not by way of limitation.

What is claimed is:

1. In an abrasive slurry adapted for use in chemical-mechanical polishing of metals and oxides;
the improvement wherein the slurry consists essentially only of a mixture of at least two inorganic metal oxides selected from the group consisting of ceria, silica, alumina, zirconia, germania and titania.

2. An abrasive slurry as defined in claim 1 wherein the abrasive mixture comprises alumina and ceria.

3. An abrasive slurry as defined in claim 2 wherein the abrasive mixture consists of a ratio of ceria to alumina of from about 1:5 to about 5:1; the ceria possessing a mean primary particle size less than 20 nm; and the alumina is characterized as being of a magnitude larger than the ceria.

4. An abrasive slurry as defined in claim 3 wherein the ceria is commercially available from Nyacol Nano Technology, Inc. as Product code DP 6255.

5. An abrasive slurry as defined in claim 1 wherein the abrasive mixture comprises alumina and silica.

6. An abrasive slurry as defined in claim 5 wherein the abrasive mixture consists essentially of a smaller mean particle size inorganic metal oxide and a larger mean primary particle size inorganic metal oxide, the ratio by weight of the two inorganic metal oxides being from about 1:10 to about 10:1.
